(19) United States
(12) Patent Application Publication
(10) Pub. No.: US 2003/0208887 A1
(43) Pub. Date: Nov. 13, 2003

(54) Clip

(76) Inventor: Yong-woo Lee, Gimpo (KR)

Correspondence Address: DARBY & DARBY P.C., Post Office Box 5257, New York, NY, 10150-5257, US

(21) Appl. No.: 10/141,164

(22) Filed: May 7, 2002

(51) Int. Cl. B42F 1/02

(52) U.S. Cl. 24/67.9; 24/546

(57) ABSTRACT

Disclosed is a clip having a base part and a pair of grasping arms. The grasping arms are integrally formed with and bent forward from upper and lower ends of the base part in a manner such that lip portions are formed adjacent to free ends of the grasping arms. The lip portions are abutted against each other with a substantial degree of elasticity. Each lip portion is projectedly formed at both widthwise ends thereof with a pair of lug portions. A pair of first projections are formed on an inner surface of a first grasping arm such that they extend over an entire width of the first grasping arm and define therebetween an engaging groove. A second projection is formed on an inner surface of a second grasping arm such that it extends over an entire width of the second grasping arm and is engaged into the engaging groove of the first grasping arm.

### BACKGROUND OF THE INVENTION

1. Field of the Invention

The present invention relates to a clip, and more particularly, the present invention relates to a clip which can be driven by a clip driver to bind sheets of paper such as a document or the like.

2. Description of the Related Art

Generally, clips having a variety of shapes are used to temporarily bind sheets of paper such as documents or the like while not causing mar or impairment of the sheets.

FIG. 1a is a perspective view illustrating a conventional clip, and FIG. 1b is a side view illustrating the conventional clip. The conventional clip is made of a metallic material and has a base part and a pair of grasping arms 10. The pair of grasping arms 10 are integrally formed with upper and lower ends, respectively, of the base part. The respective grasping arms 10 are bent forward from the upper and lower ends of the base part by an angle of greater than 90° in a manner such that lip portions 20 are formed adjacent to free ends of the grasping arms 10. The lip portions 20 are abutted against each other with a substantial degree of elasticity. A pair of lug portions 30 are projectedly formed at both widthwise ends, respectively, of each lip portion 20. As can be readily seen from FIGS. 1 and 2, the free ends of the grasping arms 10 are diverged. Upon use, as clip opening springs of a clip driver (not shown) are respectively inserted between upper and lower lug portions 30, the lip portions 20 are opened. In this state, sheets of paper such as a document or the like can be firmly clipped after being inserted into between the opened lip portions 20.

However, the conventional clip constructed as mentioned above suffers from defects in that, since the clip is usually made of costly carbon steel having a large degree of elasticity with a view of increasing binding force, economic loss is caused.

To cope with this problem, the clip may be made of a plastic material. Nevertheless, in this case, because the clip made of the plastic material has poor binding force due to its material characteristic, it is difficult to firmly clip the sheets of paper.

### SUMMARY OF THE INVENTION

Accordingly, the present invention has been made in an effort to solve the problems occurring in the related art, and an object of the present invention is to provide a clip which has a construction capable of rendering a high level of grasping force upon binding sheets of paper, while being made of an inexpensive plastic material.

In order to achieve the above object, according to the present invention, there is provided a clip having a base part and a pair of grasping arms, the grasping arms being integrally formed with and bent forward from upper and lower ends of the base part in a manner such that lip portions are formed adjacent to free ends of the grasping arms, the lip portions being abutted against each other with a substantial degree of elasticity, each lip portion being projectedly formed at both widthwise ends thereof with a pair of lug portions: wherein a pair of first projections are formed on an inner surface of a first grasping arm such that they extend over an entire width of the first grasping arm and define therebetween an engaging groove, and a second projection is formed on an inner surface of a second grasping arm such that it extends over an entire width of the second grasping arm and is engaged into the engaging groove of the first grasping arm.

### BRIEF DESCRIPTION OF THE DRAWINGS

The above objects, and other features and advantages of the present invention will become more apparent after a reading of the following detailed description when taken in conjunction with the drawings, in which:

FIG. 1a is a perspective view illustrating a conventional clip;

FIG. 1b is a side view illustrating the conventional clip;

FIG. 2 is a partially enlarged perspective view illustrating a clip in accordance with a first embodiment of the present invention;

FIG. 3 is a partially enlarged side view illustrating the clip according to the first embodiment of the present invention;

FIG. 4 is a partially enlarged perspective view illustrating a clip in accordance with a second embodiment of the present invention; and

FIG. 5 is a partially enlarged side view illustrating the clip according to the second embodiment of the present invention.

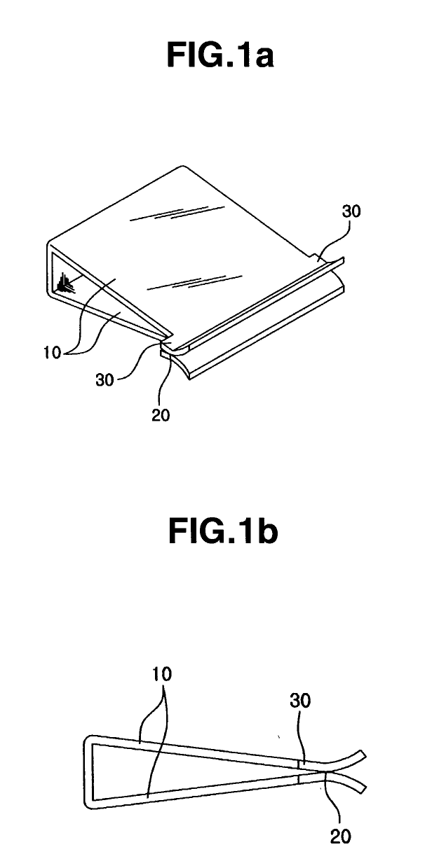

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

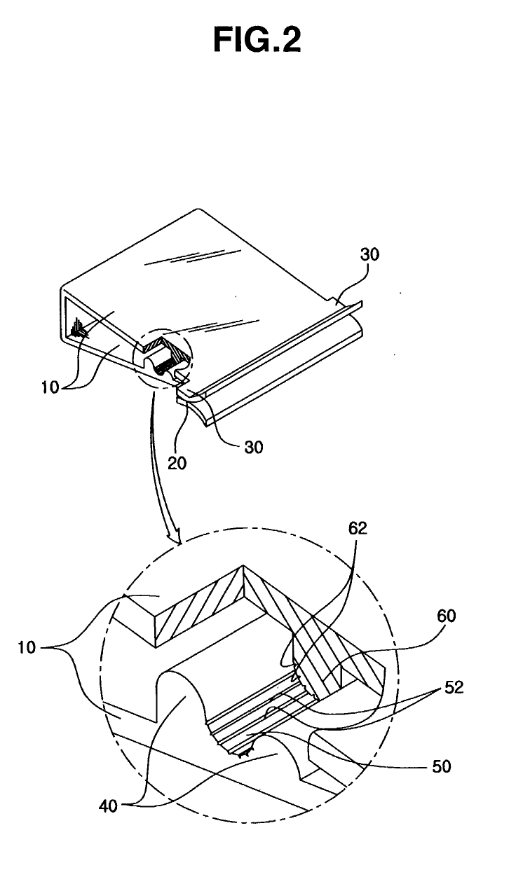

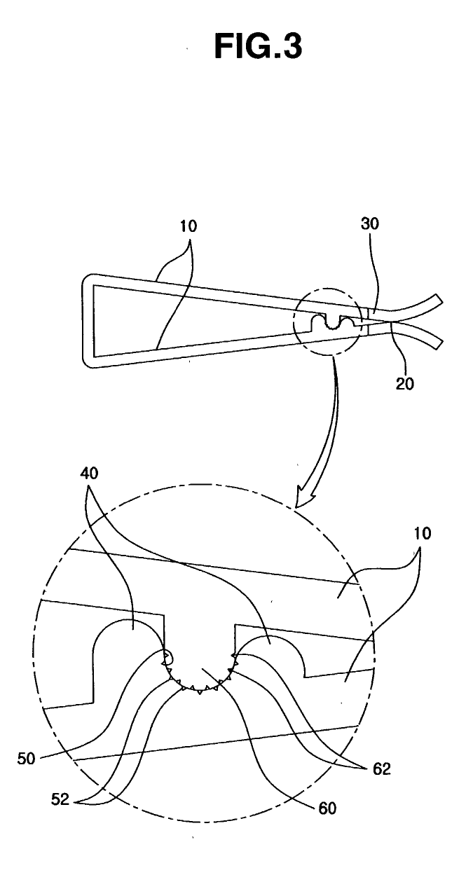

FIG. 2 is a partially enlarged perspective view illustrating a clip in accordance with a first embodiment of the present invention, and FIG. 3 is a partially enlarged side view illustrating the clip according to the first embodiment of the present invention. The clip according to this embodiment of the present invention has a base part and a pair of grasping arms 10. The pair of grasping arms 10 are integrally formed with upper and lower ends, respectively, of the base part. The respective grasping arms 10 are bent forward from the upper and lower ends of the base part by an angle of greater than 90° in a manner such that lip portions 20 are formed adjacent to free ends of the grasping arms 10. The lip portions 20 are abutted against each other with a substantial degree of elasticity. A pair of lug portions 30 are projectedly formed at both widthwise ends, respectively, of each lip portion 20. The free ends of the grasping arms 10 are diverged outward. Upon use, as clip opening springs of a clip driver (not shown) are respectively inserted between upper and lower lug portions 30, the lip portions 20 are opened. And, in this state, sheets of paper such as a document or the like can be firmly clipped after being inserted into between the opened lip portions 20.

According to the present invention, auxiliary grasping means is provided adjacent to the lip portions 20. The auxiliary grasping means comprises a pair of first projections 40, an engaging groove 50 and a second projection 60.

Here, the pair of first projections 40 are formed on an inner surface of a lower grasping arm 10 in a manner such that they extend over an entire width of the lower grasping arm 10. By this fact, the engaging groove 50 is defined between the pair of first projections 40. The second projection 60 is formed on an inner surface of an upper grasping arm 10 in a manner such that it extends over an entire width of the upper grasping arm 10 and is engaged into the engaging groove 50 of the lower grasping arm 10. In this way, by virtue of the first and second projections 40 and 60 and the engaging groove 50, mechanical engagement of the type implemented between prominences and depressions is effected.

As the lip portions 20 are closed or opened, the second projection 60 can be selectively engaged into or disengaged from the engaging groove 50.

Also, according to this first embodiment of the present invention, over a region where the second projection 60 is engaged into the engaging groove 50, a plurality of first transversely extending channels 52 are defined on a bottom surface of the engaging groove 50, and a plurality of second transversely extending channels 62 are defined on an outer surface of the second projection 60. As a consequence, frictional force for grasping the sheets of paper inserted between the engaging groove 50 and the second projection 60 is increased.

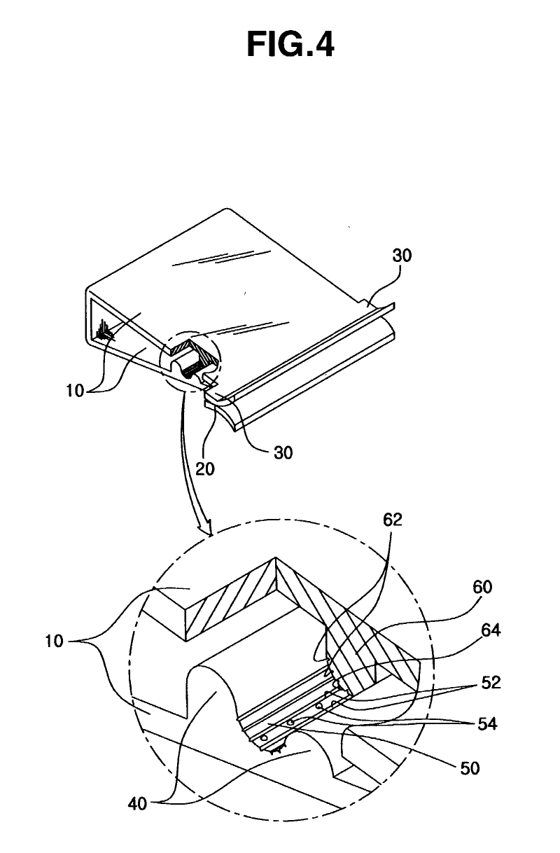

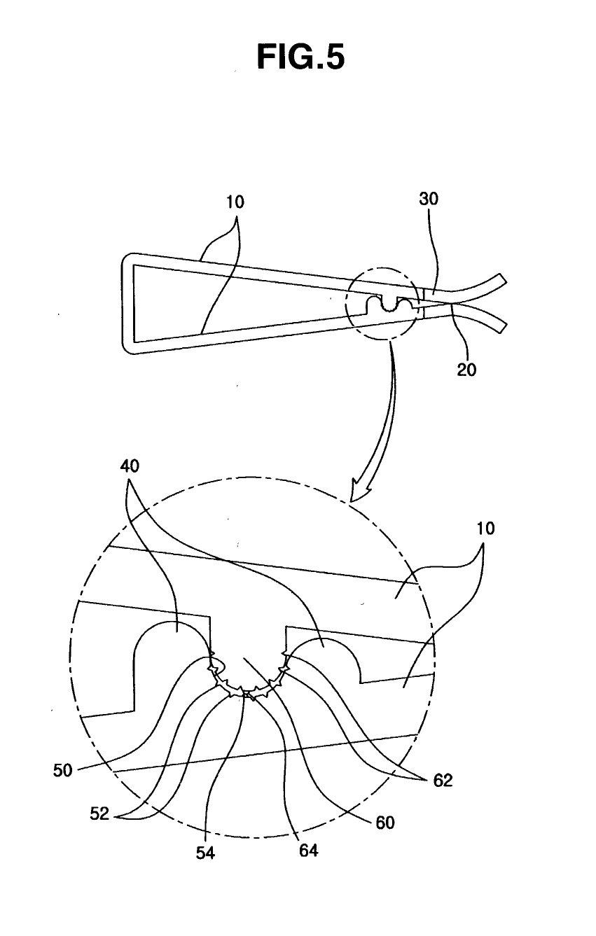

FIG. 4 is a partially enlarged perspective view illustrating a clip in accordance with a second embodiment of the present invention, and FIG. 5 is a partially enlarged side view illustrating the clip according to the second embodiment of the present invention. According to this second embodiment of the present invention, a plurality of first protrusions 54 are formed on the bottom surface of the engaging groove 50 to be spaced apart one from another by a predetermined distance, and a plurality of second protrusions 64 are formed on the outer surface of the second projection 60 to be spaced apart one from another by the predetermined distance, whereby it is possible to more firmly clip the sheets of paper inserted between the engaging groove 50 and the second projection 60.

Hereafter, operation of the clip according to the present invention, constructed as mentioned above, will be described.

In order to bind the sheets of paper such as a document or the like using the clip according to the present invention, as the clip opening springs of the clip driver are respectively inserted between the upper and lower lug portions 30, the lip portions 20 are opened, and thereby, the second projection 60 is disengaged from the engaging groove 50 to define a gap of a preset interval therebetween. After the sheets of paper such as a document or the like are inserted into between the opened lip portions 20, by pushing a lever of the clip driver, the clip is moved toward the lip portions 20. When the clip is removed from the clip opening springs, the lip portions 20 are returned to their original closing position due to elasticity. By this fact, the clip grasps the sheets of paper between the lip portions 20. At this time, due to the fact that the second projection 60 is engaged into the engaging groove 50 defined between the pair of first projections 40, it is possible to firmly bind the sheets of paper.

Further, due to the fact that the first transversely extending channels 52 are defined on the bottom surface of the engaging groove 50 and the second transversely extending channels 62 are defined on the outer surface of the second projection 60, frictional force between the engaging groove 50 and the second projection 60 is increased, whereby the sheets of paper inserted between the engaging groove 50 and the second projection 60 is prevented from slipping.

Furthermore, since the first protrusions 54 are formed on the bottom surface of the engaging groove 50 and the second protrusions 64 are formed on the outer surface of the second projection 60, force for clipping the sheets of paper between the engaging groove 50 and the second projection 60 is increased, whereby it is possible to more firmly clip the sheets of paper.

As apparent from the above description, the clip according to the present invention provides advantages in that, even when the clip is made of a plastic material, it is possible to firmly clip sheets of paper such as a document or the like due to the presence of auxiliary grasping means which enables mechanical engagement of the type implemented between prominences and depressions.

Consequently, due to formation of the clip using a plastic material, an economical efficiency can be improved through a decrease in manufacturing cost.

Further, due to the fact that the clip is made of a plastic material, a possibility of a user to be wounded by a sharpened edge of a clip made of a metallic material is suppressed, and the sheets of paper are prevented from being marred or impaired, which is otherwise caused due to corrosion of the metallic clip. In addition, since the clip can be formed to have a diversity of colors by a characteristic of the plastic material, the clip can provide an aesthetic appearance.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A clip having a base part and a pair of grasping arms, the grasping arms being integrally formed with and bent forward from upper and lower ends of the base part in a manner such that lip portions are formed adjacent to free ends of the grasping arms, the lip portions being abutted against each other with a substantial degree of elasticity, each lip portion being projectedly formed at both widthwise ends thereof with a pair of lug portions:
wherein a pair of first projections are formed on an inner surface of a first grasping arm such that they extend over an entire width of the first grasping arm and define therebetween an engaging groove, and a second projection is formed on an inner surface of a second grasping arm such that it extends over an entire width of the second grasping arm and is engaged into the engaging groove of the first grasping arm.

2. The clip as set forth in claim 1, wherein a plurality of first transversely extending channels are defined on a bottom surface of the engaging groove and a plurality of second transversely extending channels are defined on an outer surface of the second projection, to increase frictional force.

3. The clip as set forth in claims 1 or 2, wherein a plurality of first protrusions are formed on the bottom surface of the engaging groove to be spaced apart one from another by a predetermined distance, and a plurality of second protrusions are formed on the outer surface of the second projection to be spaced apart one from another by the predetermined distance.
